(19) United States
(12) Patent Application Publication
(10) Pub. No.: US 2010/0186718 A1
(43) Pub. Date: Jul. 29, 2010

(54) Method for operating an injector

(76) Inventors: Manfred Klein, Gerlingen (DE); Jens-holger Barth, Felbach (DE); Andreas Schmitt, Ditzingen (DE); Markus Krieg, Ditzingen (DE)

Correspondence Address: KENYON & KENYON LLP, ONE BROADWAY, NEW YORK, NY, 10004, US

(21) Appl. No.: 12/308,339

(22) PCT Filed: Dec. 3, 2007
(86) PCT No.: PCT/EP2007/063131

§ 371 Date: Apr. 14, 2010

(30) Foreign Application Priority Data
Dec. 20, 2006 (DE) 10 2006 060 311.7

(51) Int. Cl. F02M 51/00; B05B 1/30; F02B 3/00; F02D 41/30

(52) U.S. Cl. 123/472; 239/584; 123/299; 701/103

(57) ABSTRACT

A method is described for operating an injector, in particular an injector of an injection system of an internal combustion engine, the injector including a piezoelectric actuator that is connected to a valve needle via a coupling element, an electric voltage being applied to the piezoelectric actuator, resulting in an increase and/or decrease in the length of the piezoelectric actuator, a holding voltage being applied to the piezoelectric actuator when the injector is closed. The voltage of the piezoelectric actuator is brought to the holding voltage by a recharge sequence.

### FIELD OF THE INVENTION

The present invention relates to a method for operating an injector, in particular an injector of an injection system of an internal combustion engine, the injector including a piezoelectric actuator that is connected to a valve needle via a coupling element, an electric voltage being applied to the piezoelectric actuator, resulting in an increase and/or decrease in length of the piezoelectric actuator, such that when the injector is closed a holding voltage is applied to the piezoelectric actuator. The present invention also relates to a device, in particular a control unit, having an arrangement for operating an injector, and a computer program having program code for performing the method.

### BACKGROUND INFORMATION

In a common rail piezoelectric injection system having a directly controlled nozzle needle, the piezoelectric actuator must be charged to keep the injector closed. To open the injector during an injection, the actuator is discharged. A generic common rail piezoelectric injection system is discussed in DE 10 2005 032841, for example. The voltage that must be applied to an actuator to keep the injector securely closed depends on the rail pressure. In addition, the voltage at the start of a discharge operation of the actuator has an influence on the opening point of the injector and thus on the injection quantity. Due to the manufacturing process, piezoelectric actuators have a spontaneous discharge which results in a drop in the voltage of a charged actuator over time. This in turn results in a shift in the opening point and the opening duration and thus the injection quantity is subject to scattering that is dependent on the operating point because the actuator voltage depends on how long there is no charge, i.e., discharge and thus energization of the actuator.

### SUMMARY OF THE INVENTION

An object of the exemplary embodiments and/or exemplary methods of the present invention is to compensate for scattering in injection point and injection quantity caused by spontaneous discharge of piezoelectric actuators.

This object is achieved by a method for operating an injector, in particular an injector of an injection system of an internal combustion engine, the injector including a piezoelectric actuator that is connected to a valve needle via a coupling element, an electric voltage being applied to the piezoelectric actuator, resulting in an increase and/or decrease in length of the piezoelectric actuator, such that when the injector is closed a holding voltage is applied to the piezoelectric actuator, the voltage of the piezoelectric actuator being brought to the holding voltage by a recharge sequence. The recharge sequence may include at least one energization of the piezoelectric actuator.

Energization is understood here in particular to mean applying a voltage to the piezoelectric actuator, resulting in a current flow and thus a change in the charge and voltage of the piezoelectric actuator. Spontaneous discharge of the piezoelectric actuator is thus compensated by the method according to the present invention, so that the holding voltage is again applied to the actuator before the start of an injection regardless of the period of time that has elapsed since the actuator was brought to the holding voltage. It is self-evident that the holding voltage itself represents a voltage range, because this may also be subject to inaccuracy.

The spontaneous discharge of piezoelectric actuators is compensated by the method according to the present invention, and the voltage at all actuators is constantly being adjusted to the particular operating point. This ensures that each injector remains securely closed between triggerings at any rail pressure and that the possible voltage swing is sufficient for producing the desired injection quantity at a certain operating point. After initialization of the control unit, the recharging function ensures that all actuators are charged to a voltage as a function of the rail pressure at the moment of buildup of the rail pressure when the starter is operated. During the after-run mode of the control unit, it must be ensured that all actuators are discharged back to a voltage of 0 volt within a certain period of time to ensure shock protection.

If this time is long enough, the injectors remain closed due to their design, despite the drop in voltage, so that unwanted injections are prevented. One advantage of constant voltage correction at the piezoelectric actuators is that the injector is in a hydraulic steady state at the start of an injection sequence and thus a high constancy in quantity is ensured. If the actuator were charged to the operating point-dependent voltage only shortly before the particular triggering, there might thus be high voltage swings due to the transient response of the hydraulic coupler between the actuator and the nozzle needle and thus high quantity tolerances. Furthermore, the method according to the present invention ensures that between two injections the actuator is constantly charged to a voltage that keeps the injector securely closed.

It may be provided that the voltage of the piezoelectric actuator is brought to the holding voltage by a point in time so far before the injection that the injector is in a steady state at the start of the injection. In addition, according to the present invention, the recharge sequence includes at least one charge edge and/or at least one discharge edge. It is possible to ascertain on the basis of a measured actuator voltage whether it is above or below the holding voltage and therefore a charge edge or discharge edge is used. The recharge sequence may be activated by a static interrupt of a control unit for triggering a pilot injection.

Alternatively it is possible to provide for the recharge sequence to be activated immediately after the end of the last injection into a cylinder during an operating cycle, as a function of the operating point. The recharge sequence may then be activated at high rotational speeds immediately after the end of the last injection into a cylinder during an operating cycle. During the control unit run-up, the recharge sequence may be performed with a constant time grid for energization of the piezoelectric actuator. During the after-run mode of the control unit, the piezoelectric actuators may be discharged in stages. In stages means here that the piezoelectric actuators are not discharged continuously but instead through energization that is discrete in time.

The object mentioned in the introduction is also achieved by a device, in particular a control unit, having an arrangement for operating an injector, in particular an injector of an injection system of an internal combustion engine, the injector including a piezoelectric actuator that is connected to a valve needle via a coupling element, an electric voltage being applied to the piezoelectric actuator, resulting in an increase and/or decrease in the length of the piezoelectric actuator, such that when the injector is closed a holding voltage is applied to the piezoelectric actuator, the voltage of the piezoelectric actuator being brought to the holding voltage by a recharge sequence. The object mentioned in the introduction is also achieved by a computer program having program code for performing all the steps by a method according to the present invention when the program is executed in a computer.

An exemplary embodiment of the present invention is explained in greater detail below on the basis of the accompanying drawings.

### BRIEF DESCRIPTION OF THE DRAWINGS

FIG. 1 shows a schematic diagram of a fuel injection system of a motor vehicle having an injector having a piezoelectric actuator.

FIG. 2 shows a schematic diagram of the hysteresis curve of a piezoelectric actuator with double repolarization.

FIG. 3 shows a diagram of the voltage applied to a piezoelectric actuator over time.

FIG. 4 shows an enlargement of section D in FIG. 3.

FIG. 5 shows a flow chart of the method.

### DETAILED DESCRIPTION

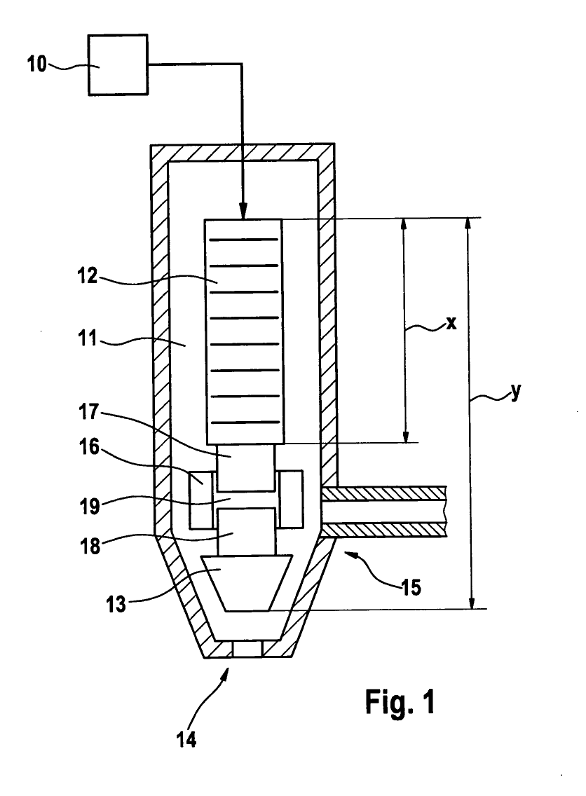

FIG. 1 shows a fuel injection system of a motor vehicle having a control unit 10 and an injector 11. Injector 11 is provided with a piezoelectric actuator 12, which is triggered by control unit 10. In addition, injector 11 has a valve needle 13, which may sit on a valve seat 14 in the interior of the housing of injector 11. If valve needle 13 is lifted up from the valve seat, injector 11 is opened and fuel is injected. This state is depicted in FIG. 1. If valve needle 13 sits on valve seat 14, injector 11 is closed. The transition from the closed state to the opened state is accomplished with the help of piezoelectric actuator 12. To achieve this, an electric voltage is applied to actuator 12, inducing a change in length of a piezo stack, which is in turn utilized for opening and/or closing injector 11. Injector 11 has a hydraulic coupler 15. To this end, a coupler housing 16 is provided inside injector 11, two pistons 17, 18 being guided in the housing. Piston 17 is connected to actuator 12 and piston 18 is connected to valve needle 13. A chamber 19 positioned between two pistons 17, 18 forms a piston/cylinder system for transmitting the force exerted by actuator 12 to valve needle 13. Coupler 15 is surrounded by fuel under pressure. The volume of chamber 19 is also filled with fuel. The volume of chamber 19 may adapt to the particular prevailing length of actuator 12 over a relatively long period of time via the guide gaps between two pistons 17, 18 and coupler housing 16.

With short-term changes in length of actuator 12, the volume of chamber 19 and thus its length remain almost unchanged, however, and the change in length of actuator 12 is transmitted to valve needle 13. The guide gaps between two pistons 17 and 18 and coupler housing 16 may form a valve which has different flow resistances and/or flow coefficients in different directions of flow or as a function of the position of pistons 17, 18 in relation to coupler housing 16. For example, one or both pistons may have grooves having groove bottoms that vary in depth or the like to vary the effective flow area between pistons 17, 18 and coupler housing 16. The speed of movement of pistons 17, 18 relative to one another is set, e.g., by the guide plays between pistons 17, 18 and coupler housing 16 or by a small throttle having a direction-dependent flow coefficient.

Injector 11 is always in its closed state regardless of the operating point of actuator 12 when actuator 12 remains unchanged at any point in hysteresis curve 40 for a relatively long period of time. Injector 11 is then opened through a comparatively rapid shortening of actuator 12 from this point in hysteresis curve 40. Closing of injector 11 is achieved by the return of actuator 12 back to its operating point before the start of injection.

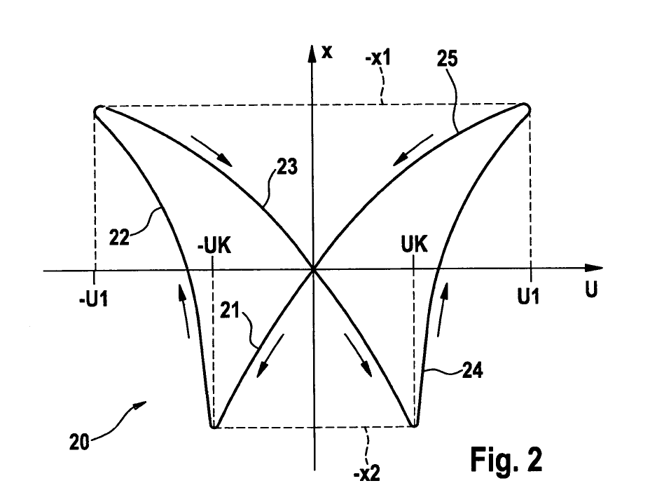

FIG. 2 shows the relationship between voltage U applied to a piezoelectric actuator and the resulting change in length, i.e., shortening x of the actuator. This relationship forms a hysteresis curve 20 of the actuator. It is assumed that the actuator is at the zero point of hysteresis curve 20, so no voltage is applied to the actuator and the actuator has neither an increase nor a decrease in length. In addition, it is assumed that the actuator is polarized momentarily in the direction of positive voltage. If the voltage at the actuator now changes in the negative direction, this results in a shortening of the actuator. This is shown by branch 21 of hysteresis curve 20. If negative voltage −UK is reached, corresponding to the so-called coercitive field strength, the actuator begins to repolarize. At this negative voltage −UK, the actuator experiences its greatest shortening −x2. If the voltage then drops below voltage −UK corresponding to the coercitive field strength, then the length of the actuator increases again.

This is apparent from branch 22 of hysteresis curve 20. At negative voltage −U1, the actuator then has its greatest length increase x1. In addition, passing through branch 22 of hysteresis curve 20 results in a change in polarization of the actuator. If the voltage applied to the actuator is now increased again in the positive direction, branch 23 of hysteresis curve 20 is passed through. The length of the actuator changes from length increase x1 back to shortening −x2. The actuator has its greatest shortening −x2 at positive voltage UK. After exceeding positive voltage UK, there is again a repolarization of the actuator, so that branch 24 is passed through with a further increase in voltage. This branch 24 ends at positive voltage U1, at which the actuator has its greatest length increase x1. If the voltage applied to the actuator is again decreased, the length of the actuator decreases again. This is apparent from branch 25 of hysteresis curve 20. Branch 25 then develops back into branch 21 of hysteresis curve 20 in the range of the zero point.

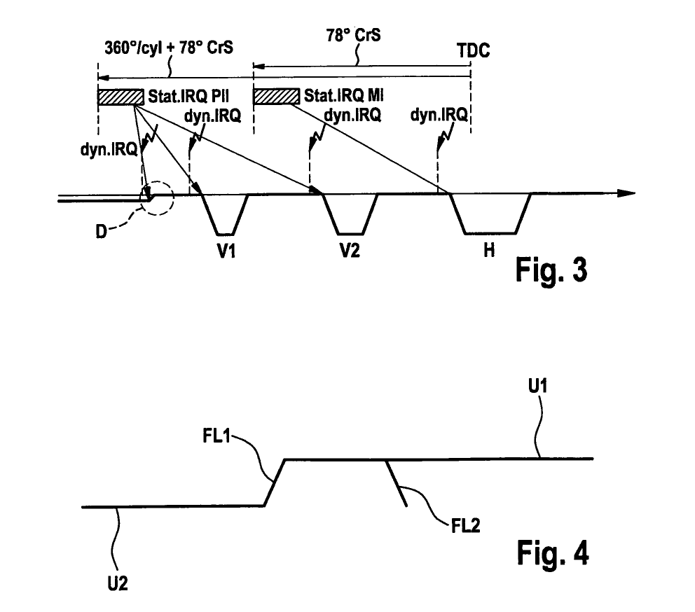

FIG. 3 shows a diagram of an exemplary embodiment of a recharge sequence according to the present invention as a function of time. This shows the voltage characteristic of voltage U of piezoelectric actuator 12 over time t. An interrupted injection is recognizable by a drop in voltage U to a lower voltage level U_{B}; the example in FIG. 3 illustrates a main injection H and two pilot injections V1 and V2. Before each injection, i.e., the main injection and the pilot injections, a dynamic interrupt DYN.IRQ is generated, in which the control unit is instructed at each of the interrupts to stop an injection. Dynamic interrupts DYN.IRQ are each generated from static interrupts of the control unit at certain crankshaft angles; these are a static interrupt Stat. IRQ.PIL and a static interrupt Stat. IRQ.MI here. Static interrupt Stat. IRQ.MI is used to determine dynamic interrupt DYN.IRQ_H for the main injection, while static interrupt Stat. IRQ.PIL is used to determine dynamic interrupts DYN.IRQ_V1 for stopping first pilot injection V1 and dynamic interrupt DYN.IRQ_V2 for topping second pilot injection V2.

In addition, static interrupt IRQ.PIL is used to ascertain the start of a recharge sequence NL. Recharge sequence NL is depicted as section “D” in FIG. 3, enlarged in FIG. 4, and includes a rising edge FL1 and a falling edge FL2. Starting from a voltage U2, which is lower than holding voltage U1, voltage U applied to piezoelectric actuator 12 is raised to holding voltage U1 by the rising edge. In this case, falling edge FL2 has no effect. If voltage U applied to the piezoelectric actuator should be higher than holding voltage U1, so that rising edge FL1 has no effect, then the voltage is lowered to the value of holding voltage U1 with falling edge FL2. The period of time between the end of recharge sequence NL and dynamic interrupt DYN.IRQ_V1 for stopping the first pilot injection is selected, so that injector 11 is in the steady state, so in particular the coupling element no longer performs any compensating movement.

A recharge sequence includes a charge edge FL1 and a discharge edge FL2, which are executed one after the other in direct succession and both of which have the same target voltage, namely holding voltage U1. Depending on the starting voltage, one of the two edges produces the approximation to the setpoint voltage, which here is holding voltage U1, while the other edge has no effect. Alternatively, voltage U of piezoelectric actuator 12 may be measured and it is possible to determine whether it is above or below holding voltage U1. Charge edge FL1 or discharge edge FL2 is next selected to bring voltage U to holding voltage U1. If voltage U is below holding voltage U1, then charge edge FL1 is used; if voltage U is above holding voltage U1, then discharge edge FL2 is used.

After initialization of the control unit and below a rotational speed threshold n_{RECHG} at which no injections are enabled and thus no rotational speed interrupts are generated, recharging of actuators 12 takes place in synchronization in a predefined grid, e.g., in a 10-millisecond grid.

Above rotational speed threshold n_{RECHG}, the static interrupt of pilot injections Stat. IRQ.PIL is used to program, i.e., trigger, the recharge sequence. The recharge sequence is programmed like that of a pilot injection, i.e., here again a dynamic interrupt DYN.IRQ_NL is generated. The start of triggering of the recharge sequence is applied as a function of the operating point and must occur before the first triggering of an injection sequence on this cylinder. The interval between the recharge sequence and the next following triggering should be as great as possible, utilizing the available angle range. This ensures that the time between the recharge sequence and the first triggering of an injection (this is first pilot injection V1 in FIG. 3) is long enough to allow hydraulic coupling element 15 to reach a steady state.

If the period of time between the static interrupt of the pilot injections Stat. IRQ.PIL and first pilot injection V1 is not sufficient to program a recharge sequence at high rotational speeds, then this is programmed after the end of the last injection of the preceding cylinder. The static interrupt of main injection Stat. IRQ.MI is used to determine the instant of the last triggering on the particular cylinder.

During the after-run mode of the control unit, actuators 12 are discharged in stages within a configurable period of time in a synchronous grid. The height of a voltage step is obtained from the voltage to be dissipated at the actuators and the time available to do so in the time grid used.

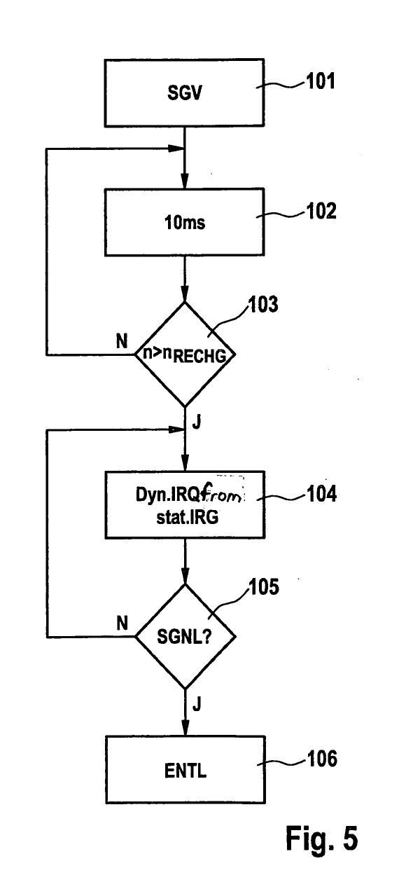

FIG. 5 shows a flow chart of the method. The method begins in step 101 with the start of control unit run-up SGV. Next, in step 102, recharging of actuators 12 is triggered in synchronization in a 10-ms grid, for example. In step 103 it is checked whether rotational speed n is greater than rotational speed threshold n_{RECHG}. If this is not the case, then in option N, it branches back to step 102, so the constant time grid is maintained. If the check in step 103 yields option J, i.e., if rotational speed n is greater than rotational speed threshold n_{RECHG}, then the dynamic interrupts in step 104 are generated from the static interrupts as described previously. Step 104 remains active until the internal combustion engine is shut down and goes into after-run mode of the control unit SGNL, which is checked constantly by a loop with the check in step 105. In the transition to after-run mode of the control unit, discharge of the actuators takes place in step 106, as described previously.

1-10. (canceled)

11. A method for operating an injector of an injection system of an internal combustion engine, comprising:
applying an electric voltage to a piezoelectric actuator that is connected to a valve needle via a coupling element resulting in at least one of an increase and a decrease in a length of the piezoelectric actuator; and
applying a holding voltage to the piezoelectric actuator when the injector is closed, wherein the voltage of the piezoelectric actuator is brought to the holding voltage by a recharge sequence.

12. The method of claim 11, wherein the recharge sequence includes at least one energization of the piezoelectric actuator.

13. The method of claim 11, wherein the voltage of the piezoelectric actuator is brought to the holding voltage at a point in time so far before an injection that the injector is in a steady state at a start of the injection.

14. The method of claim 11, wherein the recharge sequence includes at least one of at least one charge edge and at least one discharge edge.

15. The method of claim 11, wherein the recharge sequence is activated by a static interrupt of a control unit for triggering a pilot injection.

16. The method of claim 11, wherein the recharge sequence is activated immediately after the end of the last injection into a cylinder during an operating cycle.

17. The method of claim 16, wherein the recharge sequence is activated at high rotational speeds immediately after the end of the last injection into a cylinder during an operating cycle.

18. The method of claim 11, wherein the recharge sequence is performed during the control unit run-up with a constant time grid for energization of the piezoelectric actuator.

19. A control device, comprising:
a control unit having:
a first arrangement to operate an injector of an injection system of an internal combustion engine, the injector including a piezoelectric actuator that is connected to a valve needle via a coupling element; and
a second arrangement to apply an electric voltage to the piezoelectric actuator, resulting in at least one of an increase and a decrease in a length of the piezoelectric actuator, and to apply a holding voltage to the piezoelectric actuator when the injector is closed, wherein the voltage of the piezoelectric actuator is brought to the holding voltage by a recharge sequence.

20. A computer readable medium having a computer program executable by a processor, comprising:
a program code arrangement having program code for method for operating an injector of an injection system of an internal combustion engine by performing the following:
applying an electric voltage to a piezoelectric actuator that is connected to a valve needle via a coupling element resulting in at least one of an increase and a decrease in a length of the piezoelectric actuator; and
applying a holding voltage to the piezoelectric actuator when the injector is closed, wherein the voltage of the piezoelectric actuator is brought to the holding voltage by a recharge sequence.
